(19) United States
(12) Patent Application Publication
(10) Pub. No.: US 2010/0220753 A1
(43) Pub. Date: Sep. 2, 2010

(54) MONOFREQUENCY INTRA-CAVITY FREQUENCY-TRIPLED CONTINUOUS LASER

(76) Inventor: Thierry Georges, Perros-Guirec (FR)

Correspondence Address: GREER, BURNS & CRAIN, 300 S WACKER DR, 25TH FLOOR, CHICAGO, IL, 60606, US

(21) Appl. No.: 12/161,496

(22) PCT Filed: Jan. 17, 2007
(86) PCT No.: PCT/FR07/00077

§ 371 Date: Mar. 31, 2009

(30) Foreign Application Priority Data
Jan. 20, 2006 (FR) 06/00542

(51) Int. Cl. H01S 3/109; H01S 3/0941

(52) U.S. Cl. 372/22; 372/106

(57) ABSTRACT

A diode-pumped intra-cavity frequency-tripled continuous laser device, this device includes: an amplifying medium, a birefringent non-linear medium for frequency doubling, a birefringent non-linear medium for frequency tripling; and a polarizing medium arranged so as to constitute an intra-cavity birefringent filter or Lyot filter, the Lyot filter being adapted to allow monofrequency output emission from the laser device.

The present invention relates to a diode-pumped intra-cavity frequency-tripled continuous laser device, comprising an amplifying medium, a birefringent non-linear medium for frequency doubling, and a birefringent non-linear medium for frequency tripling.

It applies in particular to the design of ultra-violet (UV) or near UV (300-380 nm) lasers used in confocal microscopy, flow cytometry, cell screening, CD mastering or semiconductor inspection.

The frequency tripling of a diode-pumped continuous laser requires two non-linear conversion stages (ω+ω) and 2ω+ω) and can be efficient only inside at least one or two resonant cavities. Resonant frequency doubling is possible intra-cavity or in an external cavity, dependent on the laser emission frequency. In both cases, monofrequency fundamental emission is necessary. In the first case (intra-cavity) it is necessary to eliminate noise. In the second case it is necessary as the highly resonant cavities (high finesse) are spectrally very narrow.

The second external cavity stage is very complex if a double resonance with the fundamental wave and the harmonic wave is sought, as two optical paths (fundamental wave and harmonic wave) have to be controlled.

The present invention relates more particularly to intra-cavity tripling which is easier to implement, as the resonance of the fundamental wave is automatic. On the other hand the laser cavity is extended by the insertion of non-linear crystals and it is much more difficult to make the laser monofrequency.

G. Mizell's document, “355-nm CW emission using a contact-bonded crystal assembly pumped with a 1 watt 808 nm diode”, Proc. SPIE Laser Material Crystal Growth and Nonlinear Materials and Devices, vol. 3610 (1999), is known, relating to an experiment with a continuous laser with triple frequency, but of very low power (200 μW max) and not allowing monofrequency operation.

There are numerous publications relating to intra-cavity frequency-tripled lasers but only with impulsive operation, which at least has the advantage of greatly increasing the tripling efficiency.

Finally, the use of type II doubling is a source of instability, as any rotation of the crystal greatly modifies the state of polarization of the fundamental wave in the cavity and therefore the doubling and tripling efficiency. This phenomenon is known as birefringence interference.

One purpose of The present invention is the design of a frequency-tripled continuous (CW for “continuous wave”) laser with monofrequency operation. Another purpose of the invention is the design of such a laser operating in a stable manner, i.e. if necessary limiting the phenomenon of birefringence interference.

At least one of the abovementioned objectives is achieved with a diode-pumped intra-cavity frequency-tripled continuous laser device; this device comprising:
an amplifying medium,
a birefringent non-linear medium for frequency doubling, and
a birefringent non-linear medium for frequency tripling; these media are generally crystals.

According to the invention, the laser device also comprises a polarizing medium arranged so as to constitute with at least one of the birefringent crystals an intra-cavity birefringent filter or Lyot filter, said Lyot filter being adapted to allow monofrequency output emission from said laser device. Preferably, for correct operation of the Lyot filter, the birefringence axes of the non-linear crystals are not parallel to the axes of the polarizing medium. If they are parallel, a birefringent crystal is inserted between the amplifying medium and the polarizing medium, this birefringent crystal having its birefringence axes preferably orientated at 45° to the axes of the polarizing medium.

The output emission wavelength is in the ultraviolet (UV) range. It is the whole of the resonant cavity that can constitute a Lyot filter. The polarizing medium is advantageously arranged between the amplifying medium and the frequency-doubling medium.

More precisely, these media are crystals such as:
for the amplifying medium: Nd:YAG and Nd:YVO₄ or any other crystal or glass doped with any rare earth or in general any doped glass or crystal having a transition capable of oscillating in a laser cavity,
for the frequency-doubling medium: KTP, KNbO₃, BBO, BiBO, and LBO or any other non-linear crystal adapted to frequency doubling,
for the frequency-tripling medium: BBO, BIBO, LBO or any other non-linear crystal adapted to frequency tripling.

With the laser device according to the invention, by using a pump diode with 2.4 W at 808 nm, monofrequency operation at 355 nm with power exceeding 5 mW has been achieved experimentally.

The other advantage of the Lyot filter is that the emitted wavelength is the one with the lowest losses and it is therefore the one the polarization of which at the polarizer output is parallel to the lowest loss axis. The distribution of the powers between the two axes of the doubling and tripling crystals is therefore perfectly controlled and stable.

Advantageously, the axes of the frequency-doubling and -tripling media are oriented approximately between 30 and 60° relative to the axes of the polarizing medium. Preferably, the orientation is 45°. With such a device, the doubling and tripling crystals can be cut and arranged so as to achieve type I and/or II phase matching, without the device becoming unstable.

According to a preferred embodiment of the invention, the polarizing medium comprises one or two Brewster interfaces (interfaces at an angle between two media with refractive indices n₁ and n₂ such that the tangent of the angle is equal to the ratio of the indices).

In particular, apart from the polarizing medium, all the other media are preferably crystals with parallel faces.

The device according to the invention constitutes a monolithic linear resonant cavity. The linear cavities are usually the shortest. This small size allows the widest possible axial mode separation, which promotes the efficiency of monofrequency operation. The design of the device can be such that each medium comprises an input face and an output face parallel with each other and with the other faces of the other media, these faces being orthogonal to the output direction of the tripled laser beam.

Advantageously, the amplifying medium, the polarizing medium and the frequency-doubling and -tripling media are optically in contact with each other, which greatly facilitates the achievement of monofrequency emission and also reduces production costs. It is therefore unnecessary to insert focussing elements making it possible to adjust the mode size into the non-linear elements as is done in the prior art.

The correct order of magnitude of the free spectral range (FSR) of the Lyot filter is the emission width Δλₑₘ of the amplifying medium (FSR=kΔλₑₘ where 0.5<k<1.5). This ensures that there is almost always a single transmission peak of the filter in the emission width. In the event that a peak is found on either side of the emission band, a modification of the temperature of the birefringent elements is sufficient to promote one of the peaks. The length of the non-linear crystals is generally optimized as a function of the UV output power. If the FSR obtained is not of the order of magnitude of the emission width, it can be adjusted by an additional birefringent crystal. In fact, it is also possible to provide a second birefringent element arranged after the polarizing medium, this second birefringent medium being adapted to adjust the Free Spectral Range (FSR) of the Lyot filter if necessary.

It is recalled that

$$F S R = \frac{{λ}^{2}}{2 \sum δ {n}_{1} {e}_{1}}$$

where e₁ and δn₁ are the thicknesses and the index differences of the different birefringent crystals forming the filter. The wavelengths at the top of the filter are λₘ=2Σ^{δn}^{₁}^{e}^{₁}/m. At these wavelengths, the polarization of the fundamental wave at the non-linear crystal input is linear and parallel to the low-loss axis of the polarizer. It is therefore the Lyot filter that controls the state of polarization in the non-linear crystals and therefore prevents birefringence interference.

According to an advantageous characteristic of the invention, the laser device comprises means for controlling the temperatures of the non-linear media. Advantageously, the matching of the filter is therefore carried out by a matching of the temperature of the crystals.

The modification of the temperature of the birefringent crystals leads to a slight displacement of the modes of the cavity and a generally more rapid variation of the central wavelength of the peak λm. Finer positioning of the wavelength of the mode at the centre of the filter can be obtained by modifying the temperature of the amplifying medium for example. Thus, it is possible to match the laser wavelength and to centre the emission mode on the filter.

For example, if 5 mm of KTP is used for 1064 nm frequency doubling and 5 mm of LBO (cut for type I phase matching for the frequency sum 1054 nm+532 nm giving 355 nm), the Lyot filter has an FSR=1.87 nm and a dFSR/dT=95 pm/° C. This last value is large compared with the cavity mode wavelength variation (typically a few pm/° C.).

A laser has been tested comprising an Nd:YVO₄ amplifier with a thickness of 1 mm and doping of 1%, a polarizer formed by 2 silica prisms separated by an air gap and the abovementioned non-linear crystals. Monofrequency operation at around 1064 nm has been clearly observed and matchability of the order of 100 pm/° C. measured.

Moreover, the laser device comprises:
a mirror which is highly reflective (HR) at the fundamental wavelength, this mirror being arranged on the input face of the amplifying medium; and
an output mirror which is highly reflective (HR) at the fundamental wavelength, this mirror being optionally arranged on the output face of the birefringent non-linear frequency-tripling medium.

The laser device can also comprise:
a mirror which is highly reflective (HR) at the frequency-tripled wavelength, this mirror being arranged between the two birefringent non-linear frequency-doubling and -tripling media; this makes it possible to protect the crystals arranged upstream of the tripling crystal against the UV waves and increase the UV output power of the laser; and
a mirror which is highly reflective (KR) at the frequency-doubled wavelength, this mirror being arranged between the polarizing medium and the birefringent non-linear frequency-doubling medium.

Other advantages and characteristics of the invention will become apparent on examination of the detailed description of an embodiment which is in no way limitative, and of the attached drawings, in which:

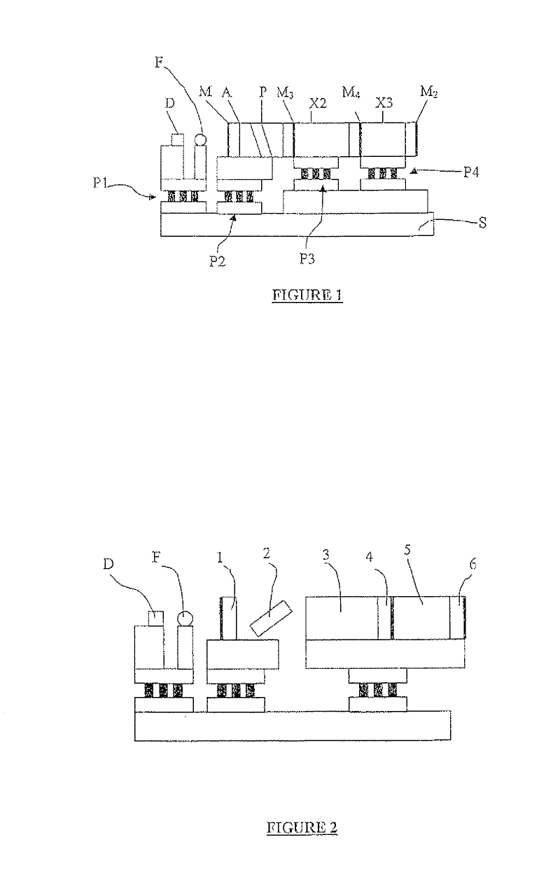

FIG. 1 is a simplified diagram of a first UV laser according to the invention;

FIG. 2 is a simplified diagram of a second UV laser according to the invention.

FIG. 1 shows a laser according to the invention for an emission of 7 mW of monofrequency power at 355 nm with a 2.4 W pump.

This laser device comprises a pump diode ID associated with a focussing element F making it possible to guide the beam emitted by the diode at 808 nm towards an input face of an amplifying crystal A. The doubling crystal X2 is arranged between the polarizing element P and the tripling crystal X3. The amplifying crystal, the polarizing element and the doubling and tripling crystals are in optical contact in this order and in linear fashion. Care was taken to insert four mirrors on each face. The mirror M1 at the input to the amplifying crystal A; the mirror M2 at the output from the tripling crystal X3; the mirror M3 between the polarizing element and the doubling crystal; the mirror M4 between the two doubling and tripling crystals.

Four Peltier elements are inserted in order to control the temperature of the diode T_{D}, the temperature of the amplifying medium T_{A} and the temperatures of the non-linear crystals Tᵢ, and T₂.

The first Peltier element P1 is in contact with the pump diode assembly D and focussing element F. This first Peltier element makes it possible in particular to control the emission wavelength of the diode and to cool this diode.

The second Peltier element P2 is in contact with the amplifying crystal and the polarizing element F. It serves to cool the amplifier and can allow fine adjustment of the cavity mode wavelength.

The third Peltier element P3 is in contact with the doubling crystal X2. The fourth Peltier element P4 is in contact with the tripling crystal X3.

The assembly is fixed onto the same support S.

In the design in FIG. 1, the output face being fiat, the fundamental beam is at its “waist” (focal point) on this mirror. The beam is therefore fairly well focussed in the tripling crystal, but it may have strongly diverged in the doubling crystal. It is generally preferable to use a length of tripling crystal which is slightly shorter than the optimum length so as not to excessively degrade the conversion of the fundamental to the second harmonic.

The frequency-tripled wave generation takes place in both directions once part of the harmonic wave is reflected by the mirror M2. It is desirable to prevent this wave (generally situated in the UV range) from propagating in the other crystals of the laser, as numerous crystals age in the presence of UV. Moreover, by adjusting the propagation phase in the tripling crystal (by temperature adjustment), it is possible to increase the output power of the tripled wave by the insertion of the mirror M3. The power of the second harmonic in the cavity is increased by inserting the mirror M4, which is reflective at the harmonic wavelength, and ensuring that the mirror M2 is also reflective at the harmonic wavelength. The cavity between the mirrors M2 and M4 becomes resonant once the round-trip propagation phase is close to 0 modulo 2π radians. This phase can be adjusted by the temperature of the doubling crystal, but above all by the choice of the emitted wavelength.

It is possible to have a single temperature control for the two non-linear crystals in accordance with FIG. 2. FIG. 2 shows a laser illustrated very schematically for which the non-linear doubling 3 and tripling 5 crystals are not directly adjacent to the amplifier 1. The Brewster plate 2 serves as a polarizing element. The crystal amplifying at 1064 nm is an Nd:YVO₄ 1.1% doped and 1 mm in length. The input face of this amplifying crystal 1 is treated to be HR (highly reflective) at 1064 nm (>99.8%). The Brewster plate 2 is a 1 mm largely fused silica plate. The non-linear group comprises four elements 3 to 6 which are optically bonded. The first crystal 3 is a 5 mm KTP cut for type II phase matching at 35° C. The second crystal 5 is a frequency-tripling crystal. Several crystals have been tested: 3 mm, 4 mm and 5 mm LBO crystals cut for type I phase matching, and 4 mm and 8 mm LBO crystals cut for type II phase matching. The LBO crystals are arranged sandwiched between two fused silica plates 4 and 6. The output plate 6 is treated to be HR at 1064 nm (99.65%) and the transmissions at 532 nm and 355 nm are respectively 2 to 7% (depending on the mirror) and 95%. The input plate 4 is treated to be HR at 355 nm (98%) in order to prevent the UV emission from penetrating into the KTP crystal.

The total length of the cavity is approximately 20 mm. The polarizing medium, which can be the combination of the Nd:YVO₄ with the Brewster plate, in combination with the birefringent crystals turned at 45° makes it possible to obtain a Lyot filter or birefringent filter. The assembly is temperature-controlled by three 2 W Peltier elements. This makes it possible to match the peak of the wavelength of the filter which can be reached in a temperature range of 1 to 2K. These two crystals tolerate wide temperature variations in phase matching, which makes it possible to preserve the non-linear frequency conversion.

The laser is pumped by a 3 W 1*100 μm 808 nm diode. The focussing element F is a GRIN lens. The diode is also temperature-controlled by a Peltier element. The amplifying crystal Nd:YVO₄ is controlled by a Peltier element.

The use of type II frequency doubling is generally inadvisable because it leads to a birefringence interference problem. The laser device in FIG. 2 remedies this problem by proposing a solution for monofrequency operation. The axes of the type II frequency-doubling crystal 3 in FIG. 2 and the axes of the tripling crystal 5 are aligned at 45° relative to Brewster's angle. The NdNVO₄ polarization is aligned with the Brewster polarization such that the whole of the cavity constitutes a birefringent filter or Lyot filter. The wavelength with 100% transmission is linearly polarized in the Brewster plate and also separates over the two polarization axes of the frequency-doubling crystal (maximum frequency-doubling efficiency).

With a 5 mm LBO tripling crystal sized for type I phase matching, the output power has reached 7 mW.

A frequency-tripled intracavity continuous (CW) low-noise laser has thus been produced, which can reasonably replace the current gas-ion UV lasers.

The table below shows a set of possible configurations of the crystals. The doubling or tripling efficiency can be 100% when the polarization is optimum. The preferred configurations are not necessarily optimized for the maximum frequency conversion, but for the best stability and simplicity.

| | | Birefringent | | Birefringent | Doubler | | | Tripler | | |
|---|---|---|---|---|---|---|---|---|---|---|
| | Amplifier | element | Polarizer | element | Type | orient. | eff. | Type | orient. | eff. |
| 1 | yes | no | yes | optional | II | 45° | 100% | I | 45° | 50% |
| | | | | 45° | | | | | | |
| 2 | yes | no | yes | optional | II | 45° | 100% | II | 45° | 50% |
| | | | | 45° | | | | | | |
| 3 | yes | yes 45° | yes | no | I | 0° | 100% | II | 0° | 100% |
| 4 | yes | no | yes | optional | I | 45° | 50% | II | 45° | 50% |
| | | | | 45° | | | | | | |
| 5 | yes | no | yes | optional | I | 45° | 50% | I | 45° | 50% |
| | | | | 45° | | | | | | |
| 6 | yes | no | yes | no | I | 0° | 100% | I | 45° | 25% |

Of course, the invention is not limited to the examples which have just been described and numerous changes can be made to these examples without the exceeding scope of the invention.

1. A diode-pumped intra-cavity frequency-tripled continuous laser device, comprising:
an amplifying medium;
a birefringent non-linear medium for frequency doubling,
a birefringent non-linear medium for frequency tripling; and
a polarizing medium arranged so as to constitute an intra-cavity birefringent filter or Lyot filter, said Lyot filter being adapted to allow monofrequency output emission from said laser device.

2. A laser device according to claim 1, wherein said polarizing medium comprises one or two Brewster interfaces.

3. A laser device according to claim 1, wherein said axes of the frequency-doubling and -tripling media are oriented approximately between 30 and 60° relative to the axes of the polarizing medium.

4. A laser device according to claim 3, wherein said orientation is 45°.

5. A laser device according to claim 1, also comprising a first birefringent element arranged after the polarizing medium, the polarization axes of which are parallel to those of the non-linear crystals, this first birefringent medium being adapted to adjust the Free Spectral Range (FSR) of the Lyot filter.

6. A laser device according to claim 1, wherein said axes of the frequency-doubling and -tripling media are parallel to the axes of the polarizing medium.

7. A laser device according to claim 6, wherein said doubling crystal is cut for type I phase matching.

8. A laser device according to claim 6, wherein said device comprises a second birefringent element arranged between the amplifying medium and the polarizing medium.

9. A laser device according to claim 8, wherein said second birefringent element is a birefringent crystal the axes of which are turned at 45° to the axes of the polarizing medium.

10. A laser device according to claim 1, wherein apart from the polarizing medium, all the other media are crystals with parallel faces.

11. A laser device according to claim 1, wherein said output emission wavelength is in the ultra-violet (UV) range.

12. A laser device according to claim 1, wherein said device constitutes a monolithic linear resonant cavity.

13. A laser device according to any claim 1, wherein said amplifying medium, the polarizing medium and the frequency-doubling and -tripling media are in optical contact with each other.

14. A laser device according to claim 1, further including means for controlling the temperature of the amplifying medium.

15. A laser device according to claim 1, further including comprises means for controlling the temperatures of the non-linear media.

16. A laser device according to claim 1, wherein said width of the Lyot filter is approximately equal to the emission width of the transition of the amplifying medium.

17. A laser device according to claim 1, further including a mirror which is highly reflective (FIR) at the fundamental wavelength, this mirror being arranged on the input face of the amplifying medium.

18. A laser device according claim 1, further including an output mirror which is highly reflective (HR) at the fundamental wavelength, this mirror being arranged on the output face of the birefringent non-linear frequency-tripling medium.

19. A laser device according to claim 1, further including a mirror which is highly reflective (HR) at the tripled wavelength, this mirror being arranged between the two birefringent non-linear frequency-doubling and -tripling media.

20. A laser device according to claim 1, further including mirror which is highly reflective (HR) at the frequency-tripled wavelength, this mirror being arranged between the birefringent non-linear frequency-doubling medium and the birefringent non-linear frequency-tripling medium.

21. A laser device according to claim 1, further including a mirror which is highly reflective (HR) at the frequency-doubled wavelength, this mirror being arranged between the polarizing medium and the birefringent non-linear frequency-doubling medium.
